(19) United States
(12) Patent Application Publication
(10) Pub. No.: US 2003/0164954 A1
(43) Pub. Date: Sep. 4, 2003

(54) Device for optoelectronically determining the length and/or the width of a body situated on a support

(76) Inventors: Edmund Gerhard, Krefeld (DE); Reinhard Viga, Krefeld (DE)

Correspondence Address: Drinker Biddle & Reath LLP, One Logan Square, 18th & Cherry Streets, Philadelphia, PA, 19103-6996, US

(21) Appl. No.: 10/090,537

(22) Filed: Mar. 4, 2002

(51) Int. Cl. G01B 11/04

(52) U.S. Cl. 356/635

(57) ABSTRACT

The invention relates to a device for the optoelectronic determination of the length (1) and/or the width (2) of a body (4) situated on a support (3), comprising a first linear guide (5) for determining the length (1) of the body and/or a second linear guide (6) for determining the width (2) of the body (4). Said first (5) and/or said second linear guide (6) can be moved along the support (3) in the longitudinal and/or transversal direction of the same, and each has at least one optoelectronic probe (7). The probe heads (7) are connected to an evaluation device (8) in such a way that the signals can be transmitted, said evaluation device converting and displaying the electrical signal emitted by the probe heads (7) into the length (1) and/or the width (2) of the body (4).

### TECHNICAL FIELD

The invention relates to a device for determining the length and/or the width of a body situated on a support.

The body can, for example, be a person's foot, whereby the device is intended in this case for determining the length and/or the width of the foot and, thereby, the correct shoe size.

### PRIOR ART

Such a device, for example, for determining the length of children's feet, is generally known and is based upon a purely mechanical measurement of the foot. The previously known device has abutting rails which are pushed from the front against the toes to determine the length of the foot and/or from the side against the already fixed foot to determine the width. As a result of the abutting rails making contact with the foot, the disadvantage arises of the foot becoming displaced as a reflex reaction, for example, or the toes pulling in, which can lead to an incorrect measurement; the measured foot length would then be shorter than the actual foot length. In order to obtain an exact measurement result, it is therefore necessary to take several measurements, which is quite unsatisfactory for all involved in the measuring process. Furthermore, there is generally the risk of reading errors by the device operator, which, when using devices for determining the length of a person's foot can lead to the allocation of an incorrect shoe size in view of the small gradings in the foot/shoe size measuring systems.

### DISCLOSURE OF THE INVENTION

The invention is based on the problem of showing a device for determining the length and/or the width of a body situated on a support, in which the abovementioned disadvantages are obviated or mitigated and in which contact is only made with the bearing surface of the body. Moreover, good accuracy of measurement should he achieved using a simple, economic design.

According to a first aspect of the present invention there is provided a device for optoelectronically determining length or width of a body situated on a support, comprising a linear guide means for determining length or width of the body; wherein said linear guide means is moveable along the lengthwise or crosswise direction of the support; wherein said linear guide means has at least one optoelectronic probe; and wherein the probe is connected using a signal line with an evaluation device for converting and displaying the electrical signal given by the probe as length or width of the body.

Preferably, the linear guide means includes a first linear guide for determining the length of the body and a second linear guide for determining the width of the body and wherein said first linear guide and said second linear guide are provided with a respective optoelectronic probe

Preferably, a first and a second linear guide are provided, the linear guides are arranged orthogonal to one another, the support is connected with the linear guides and the support and the linear guides are positioned immovably in relation to one another.

Preferably, the probes are formed as light barriers and have respectively an least one emitter and at least one detector allocated in a technical, functional manner to the emitter.

Preferably, the linear guides respectively are substantially U-shaped and underlap the support with their connecting frame, sides of the linear guides are arranged on opposite sides of the body and one of the sides has an emitter and one of the sides of each linear guide has a detector.

Preferably, the measuring beams of the emitter of each linear guide are modulated and filtered at the detector and undergo a threshold weighting.

Preferably, the linear guides can be driven by at least one stepping motor.

Preferably, the evaluation device is formed by an electronic module.

Preferably, the evaluation device comprises a classification apparatus for converting the one measuring signal at least into a size classification.

According to a second aspect of the present invention, there is provided a method for determining length or width of at least one foot of a person using the device according to the first aspect of the present invention.

In order to attempt to solve the problem, a device is provided for optoelectronically determining the length and/or the width of a body situated on a support, comprising a first linear guide for determining the length and/or a second linear guide for determining the width of the body, whereby the first and/or the second linear guide are moveable along the lengthwise and/or crosswise direction of the support, whereby the linear guides have at least one optoelectronic probe respectively and whereby the probes are connected using a signal line with an evaluation device for converting and displaying the electrical signal given by the probes as the length and/or the width of the body. By using such a device, the support only makes contact with the bearing surface of the body to be measured. The length and/or width is determined by optical measurement. By using linear guides, the device has a comparatively simple design and can be economically produced. Moreover, the device has the advantage of being compact in size. The size is only negligibly greater than the support itself on which the body to be measured is situated. The evaluation device can be spatially separated from the support and the linear guides. The signals sent by the probes to the evaluation device are converted by the evaluation device into any measuring system and are displayed and/or outputted via an interface on a peripheral unit, for example, on a monitor. Such a device is particularly advantageous for determining the length and/or the width of a person's feet since it no longer requires abutting rails which make direct and close contact with the feet. Also, the risk of reading errors by the operator is reduced to a minimum by the evaluation device and the display on which the size of the body, for example, in millimetres, or the shoe size can be directly read.

Contamination of the support, for example, with dust from the home, has no negative effect on the measurement result. The claimed device therefore has both an excellent degree of reliability and high accuracy of measurement.

Should the device be provided for determining the length and the width of a body situated on a support, the linear guides for determining the length and the width are arranged orthogonal to one another. To obtain an exact measurement result, it is preferably provided that the support is connected with the linear guides and that the support and the linear guides are positioned immovably in relation to one another. Since the device as a whole is compact in size and, therefore, is easy to transport, such an embodiment is particularly advantageous with respect to good accuracy of measurement. The support and the linear guides form a unit, whereby the unit has simply to be joined to the evaluation device. Handling is therefore made considerably easier. Adjusting the linear guides in relation to the support after manufacturing of the device is no longer necessary.

The probes can be formed as light barriers and have respectively at least one emitter and at least one detector allocated in a technical, functional manner to the emitter. Light barriers function reliably and maintenance-free over a long usable life, which is especially advantageous in view of a technically inexperienced operator.

Preferably, the linear guides are respectively U-shaped and underlap the support with a connecting frame, whereby the sides of the linear guides are arranged on opposite sides of the body and whereby one of the sides has an emitter and one of the sides of each linear guide has a detector. The emitters and the detectors of each linear guide are synchronously moved using the connecting frame.

The measuring beams of the emitter of each linear guide are preferably modulated and filtered at the detector and undergo a threshold weighting in order to avoid malfunctions, for example, as a result of outside light. The recording, feature extraction and storing of the detector signals digitalised in this way can occur in a program-controlled manner during routine probe movement. The evaluation of the signals takes place, for example, after the completion of the measuring process without a time limit.

The linear guides can be respectively driven by a stepping motor. The fundamental principal of the evaluation is based on the fixed relationship between the propulsion stepping number and the respective probe position, such that by counting the motor steps between two edge changes of the detector signals, a clear allocation of length is given. The transition of a signal level (voltage level) fromt one level value to another level value is referred to as a signal edge, whereby the transition from a lower level value to a higher level value is referred to as a rising edge and the transition from a higher level value to a lower level value is referred to as a falling edge.

The linear guides are moved, for example, in equidistant steps or at a constant speed. The evaluation device can be formed by an electronic module and can comprise, for example, a classification apparatus for converting the one measuring signal at least into a size classification. Such an evaluation device is particularly useful when the device is used for determining the size of a person's foot.

### BRIEF DESCRIPTION OF THE DRAWINGS

One embodiment of the device according to the invention is described, by way of example only, below in more detail by means of the diagrammatically illustrated figures, in which:

FIG. 1 shows a perspective view of the device;

FIG. 2 shows a side view of the device; and

FIG. 3 shows a top view of the device.

### CARRYING OUT THE INVENTION

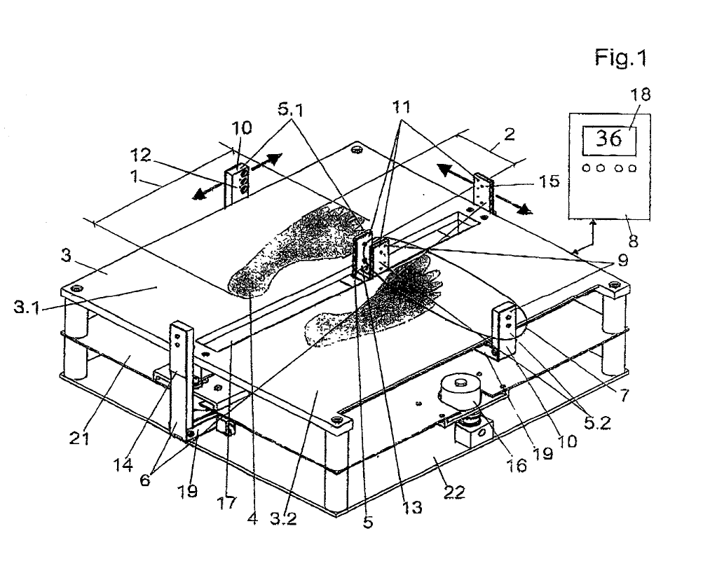

FIG. 1 shows one embodiment of the device according to the invention. In this embodiment, bodies to be measured 4 are a person's feet, the length 1 and width 2 of which are determined by optoelectronic means. Support 3 consists on the side that faces body 4 of a step-on plate 20 comprising two partial surfaces 3.1, 3.2. Partial surfaces 3.1, 3.2 are separated from one another by gap 17, whereby detectors 11 of both first linear guides 5.1 and 5.2, which are respectively provided for establishing the length of both feet, are arranged inside gap 17. Both linear guides 5.1, 5.2 are mechanically coupled with one another and are moveable only together and synchronously in the lengthwise direction of bodies to be measured 4.

Second linear guide 6 for establishing width 2 of bodies 4 is moveable in the crosswise direction of body to be measured 4 and can travel along the whole width of support 3.

Both first linear guides 5.1, 5.2 are substantially U-shaped, whereby respective connecting frame 19 runs under step-on plate 20.

An intermediate plate 21 is arranged adjacently at a distance under step-on plate 20, the driving mechanism for both linear guides 5.1, 5.2 being mounted thereon. Driving is performed by stepping motor 16 which is screwed onto intermediate plate 21. Connecting frame 19 of second linear guide 6 is arranged between intermediate plate 21 and base plate 22. Both first linear guides 5.1, 5.2 for establishing the length of bodies 4 are moveable orthogonal to second linear guide 6. Both first linear guides 5.1, 5.2 are driven in this embodiment by common stepping motor 16. Another stepping motor, which is not illustrated herein, is provided for driving second linear guide 6.

The stepping motors are actuated by evaluation device 8 having, moreover, display 18 which displays a shoe size in this embodiment. Display 18 is formed in this embodiment as a liquid crystal matrix display which can be read without difficulty even under bad lighting conditions.

First linear guide 5.1, 5.2 and second linear guide 6 are arranged orthogonal to one another. Optoelectronic probe 7, which is formed by light barriers 9, is connected using a signal line with evaluation device 8, whereby light barriers 9 have an emitter 10 and a detector 11 respectively. Due to sides 12, 11, 14, 15 of linear guides 5, 5.1, 5.2, 6 being arranged on opposite sides of body 4, these sides travel right around the feet to be measured which are placed on seep-on plate 20, to calculate the movements of probes 7.

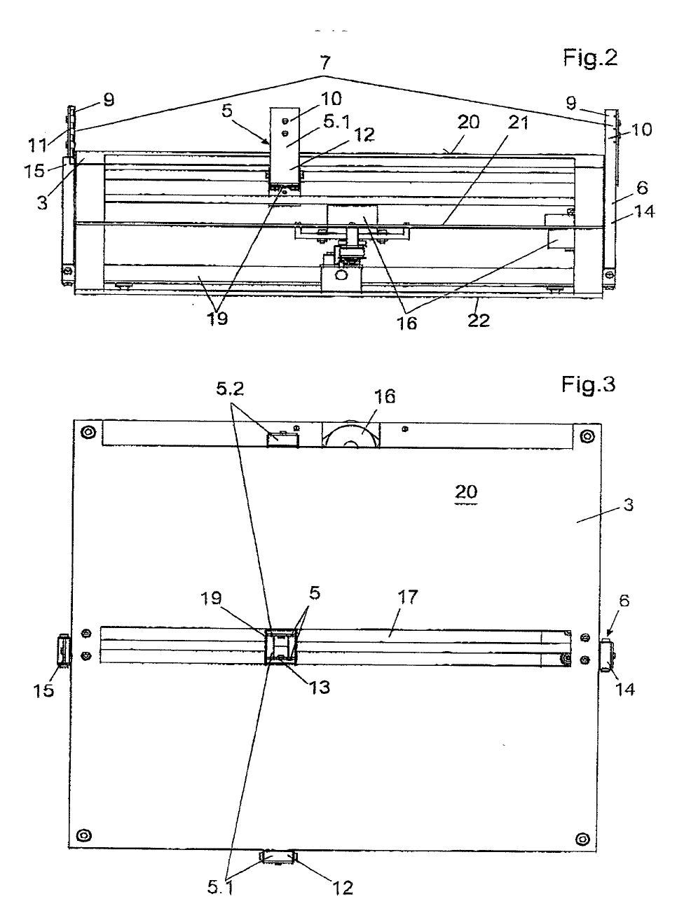

FIG. 2 shows a side view of the device and FIG. 3 shows a top view of the device.

Modifications and improvements may be made to the foregoing without departing from the scope of the present invention.

1 Device for optoelectronically determining length or width of a body situated on a support, comprising a linear guide means for determining length or width of the body; wherein said linear guide means is moveable along the lengthwise or crosswise direction of the support; wherein said linear guide means has at least one optoelectronic probe; and wherein the probe is connected using a signal line with an evaluation device for converting and displaying the electrical signal given by the probe as length or width of the body.

2. Device according to claim 1 wherein the linear guide means includes a first linear guide for determining the length of the body and a second linear guide for determining the width of the body and wherein said first linear guide and said second linear guide are provided with a respective optoelectronic probe.

3. Device according to claim 1, wherein a first and a second linear guide are provided, the linear guides are arranged orthogonal to one another, the support is connected with the linear guides and the support and the linear guides are positioned immovably in relation to one another.

4. Device according to claim 1, wherein the probes are formed as light barriers and have respectively at least one emitter and at least one detector allocated in a technical, functional manner no the emitter.

5. Device according to claim 1, wherein the linear guides respectively are substantially U-shaped and underlap the support with their connecting frame, sides of the linear guides are arranged on opposite sides of the body and one of the sides has an emitter and one of the sides of each linear guide has a detector.

6. Device according to claim 4, wherein the measuring beams of the emitter of each linear guide are modulated and filtered at the detector and undergo a threshold weighting.

7. Device according to claim 1, wherein the linear guides can be driven by at least one stepping motor.

8. Device according to claim 1, wherein the evaluation device is formed by an electronic module.

9. Device according to claim 1, wherein the evaluation device comprises a classification apparatus for conversing the one measuring signal at least into a size classification.

10. A method for determining length or width of at least one foot of a person using the device as claimed in claim 1.
